(19) United States
(12) Patent Application Publication
(10) Pub. No.: US 2003/0135426 A1
(43) Pub. Date: Jul. 17, 2003

(54) Method for purchasing over a network

(76) Inventor: Mark D. Lux, Wilton, CT (US)

Correspondence Address: MCDERMOTT WILL & EMERY, 600 13TH STREET, N.W., WASHINGTON, DC, 20005-3096, US

(21) Appl. No.: 10/326,268

(22) Filed: Dec. 23, 2002

Related U.S. Application Data
(60) Provisional application No. 60/342,753, filed on Dec. 28, 2001.

(51) Int. Cl. G06F 17/60

(52) U.S. Cl. 705/26

(57) ABSTRACT

An apparatus and method for doing business over a network, such as the Internet, is provided. In operation, a web-based automated vending device can hold out a variety of commodities for sale to the public. However, rather than offer the commodities at prices set by a vendor, the automated vending device can receive offers from potential customers and decide whether to accept or decline the various offers based on the floor-prices of the commodities. In instances where a particular offer is declined, i.e., the offer is less than the respective floor-price, the automated vending device can allow the potential buyer to submit a limited number of subsequent offers.

### FIELD OF THE INVENTION

This invention relates to methods and systems for transacting business over a network, such as the Internet.

### DESCRIPTION OF RELATED ART

As the number of distributors and other third-party resellers enter a market, the necessity for a particular competitor to become more competitive increases commensurately. Accordingly, such vendors must adapt to various market trends while still remaining competitive. One available marketing approach to is to establish a vending capability on the Internet.

A first technique that an Internet vendor may use to sell its products is to display a menu of available inventory along with a respective set of prices. Unfortunately, while this form of vending is useful, such an approach may not be the most efficient means to do business. For example, a vendor may offer a commodity at a first given price, but may be willing to settle for a lower price. At the same time, a potential buyer may be looking for the seller's commodity, and would buy the seller's commodity if the seller had offered the commodity at a marginally lower price. Accordingly, it is apparent that this form of business model may not be particularly efficient as large numbers of potential transactions acceptable to both a buyer or seller would not otherwise be made.

Furthermore, while automated Internet vending tools can lower the cost of transacting business, it should be appreciated that Internet vendors using such automatic tools must still be profitable as well as competitive. That is, Internet vendors must not only be provide competitive pricing, i.e., their prices must be comparable to those of their rival distributors/resellers on any given day, but any automated tools must simultaneously assure that the vendor makes a reasonable profit on each transaction.

As the profitability and competitiveness of a vendor is intricately intertwined with dynamic market forces, which can shift appreciably even by the hour, it should be appreciated that there is a need for methods and systems that can improve the competitiveness of Internet vending by taking into account such dynamic market forces while simultaneously maintaining profitability.

### SUMMARY OF THE INVENTION

A shortcoming of the conventional approach to Internet vending can be overcome by adopting a limited form of “back and forth” bartering. Although bartering is not a forte of machines and the Internet is not especially conducive to bartering, an efficient and competitive form of barter-like business can still be practiced over the Internet where a potential customer can submit various offers for a quantity of a particular commodity while an automated vending web-site can simply accept or refuse the offers.

In various exemplary embodiments, an apparatus and method for doing business over a network, such as the Internet, is provided. In operation, a web-based automated vending device can hold out a variety of commodities, such as a selection of bulk plastics, for sale to the public. However, rather than offer the commodities at prices set by a vendor, the automated vending device can receive offers from potential customers and decide whether to accept or decline the various offers based on the floor-prices of the commodities.

By holding commodities out to the market and accepting offers that meet respective floor-prices, a vendor is assured of making a minimum acceptable profit for each transaction even for commodities that vary dramatically in value from day to day.

In instances where a particular offer is declined, i.e., a potential buyer submitted an offer below the respective floor-price, the automated vending device can allow the potential buyer to submit a limited number of subsequent offers. By providing subsequent buying opportunities, the automated vending device can allow the potential buyer to effectively barter for the commodity. By limiting the bartering to a few offer/acceptance cycles, the automated vending device can preclude the buyer from slowly creeping up to the floor-price, which could minimize vendor profits.

### DESCRIPTION OF THE DRAWINGS

The invention is described in detail with regard to the following figures, wherein like numerals reference like elements, and wherein:

FIG. 1 is a block diagram of a networked system according to the present invention;

FIG. 2 is a block diagram of the customer terminal of FIG. 1;

FIG. 3 is a block diagram of the vendor terminal of FIG. 1;

FIG. 4 depicts the various relationships of various data useful for transacting business according to the present invention;

FIG. 5 depicts a customer terminal along with an exemplary log-on web-page;

FIG. 6 depicts a first exemplary display web-page in a hierarchy of web-pages according to the present invention.

FIG. 7 depicts a second display web-page in the exemplary hierarchy of web-pages;

FIG. 8 depicts a third display web-page in the exemplary hierarchy of web-pages;

FIG. 9 depicts the third web-page of FIG. 8 with a sub-menu;

FIG. 10 depicts a forth web-page in the exemplary hierarchy of web-pages designed for data entry;

FIG. 11 depicts the forth web-page of FIG. 10 with various exemplary data entered in various data fields;

FIG. 12 depicts an exemplary acceptance web-page according to the present invention;

FIG. 13 depicts an exemplary history web-page according to the present invention; and

FIG. 14 is a flowchart outlining an exemplary operation according to the present invention.

### DETAILED DESCRIPTION OF THE INVENTION

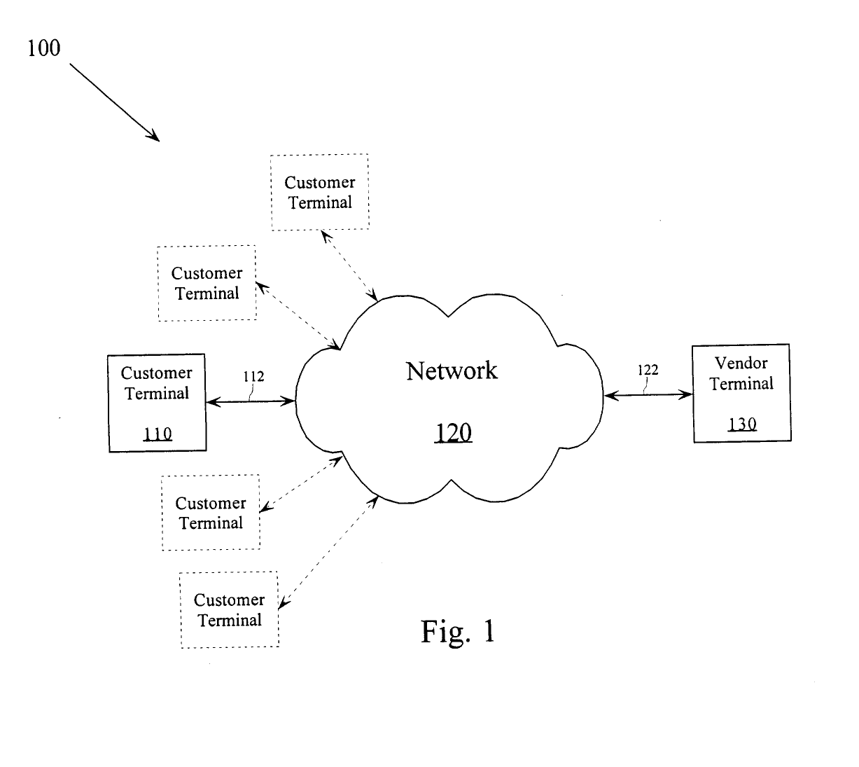

FIG. 1 is a block diagram of an exemplary communication system 100 capable of facilitating various business transactions. The communication system 100 includes a network 120 coupled to a customer terminal 110 and to a vendor terminal 130 via links 112 and 122 respectively. In operation, a potential customer using customer terminal 110 can activate a software program, such as an Internet browser, or other network communication software to establish a communication link to the vendor terminal 130. Once activated, the software link can facilitate two-way communication between the customer terminal 110 and the vendor terminal 130 via the network 120 and links 112 and 122.

During operation, as the customer establishes communication with or “logs on” to the vendor terminal 130, the vendor terminal 130 can provide the customer terminal 110 with a combination of text, audio and graphic information that can enable the customer to navigate through any number of visual fields, i.e., web-pages, related to any number of commodities that the vendor terminal 130 may offer for sale.

As contact is initially established, the customer can either create a customer account with the vendor terminal 130, or if a customer currently has an account with the vendor terminal 130, the customer can provide a customer identification number to the vendor terminal 130 along with a password that can enable the vendor terminal 130 to identify and verify the customer.

Next, the customer can navigate among the various web-pages provided by the vendor terminal 130 until the customer locates a particular commodity of interest. For example, a customer desiring to purchase several tons of a particular plastic may need to navigate about a number of web-pages to locate a web-page related to the particular plastic of interest. Once an appropriate web-page is located, the customer can provide details about his desired purchase, such as the quantity of plastic desired, whether any additives to the plastic are required, shipping information including a destination address and a shipping schedule, insurance terms and any other pertinent detail. The customer can then provide an offering price for the desired plastic as well as various other purchasing information, such as credit and/or payment terms.

Once the vendor terminal 130 has received the customer's offer, the vendor terminal 130 can make a determination as to whether the offering price is acceptable. The exemplary vendor terminal 130 can determine whether a particular offer is acceptable based on a floor-price.

A “floor-price” of a particular commodity can be the minimum amount of compensation that a vendor will accept for the commodity. Generally, a floor-price can take a large number of variables into account, such as the quantity of a desired commodity requested, the quality of the requested commodity, the availability of the commodity and various other financial considerations including taxes, shipping cost and so forth. Other factors that can influence a floor-price can include the spot-market price of the commodity in a particular market, various contractual agreements with a producer of the commodity, political considerations and so on. Still other factors that may influence a floor-price may be related to aspects personal to a potential customer, rather than the market in general. For example, because certain customers will have a better credit rating and/or have a history of prompt payment in comparison to other customers, a floor-price may be adjusted to incorporate the relative credit risk of the individual customer.

Regardless of the particular formula used to derive a floor-price, an automated vending tool programmed to barter based on such a floor price can ultimately make sales where other automated tools would fail, thus allowing a customer to advantageously buy a commodity cheaper than he might given otherwise while allowing the vendor to make a minimum acceptable profit.

In the example above, the vendor terminal 130 can be pre-programmed according to a complex parametric equation to dynamically determine a floor-price. That is, the vendor terminal 130 can determine a floor-price dynamically at any time of day taking into account any number of market forces, such as an availability of the commodity, contractual and political relationships and various aspects particular to the customer including the customer's credit history and propensity for prompt payment. While the exemplary vendor terminal 130 can further incorporate delivery information into its floor-price, it should be appreciated that in various other embodiments, the floor-price can exclude various information, such as delivery schedules, and provide to the customer a separate array of add-on prices for various available choices of delivery terms.

Assuming that the vendor terminal 130 has accepted an offer from the customer, i.e., the customer has provided an offering price that exceeds the floor-price for the particular commodity, the vendor terminal 130 can inform the customer that the offer is accepted. The exemplary vendor terminal 130 provides acceptance information to the customer using a particular web-page containing an indication of acceptance as well as detailed information about the customer's purchase and delivery terms. However, it should be appreciated that the vendor terminal 130 can confirm an acceptance using any number of avenues, such as an sending an email message, placing a phone call with an automated voice message, sending a message over a separate network and the like.

Assuming that the offer is refused, i.e., the floor-price exceeds the customer's offering price, the vendor terminal 130 can provide an appropriate indication to the customer. In various embodiments, it should be appreciated that a refusal may include an invitation for the customer to make a subsequent offer. Accordingly, the customer can submit such a subsequent offer if so inclined. The subsequent offer then can be received by the vendor terminal 130 and processed as with the first offer to provide the customer with a subsequent acceptance or refusal.

In various embodiments, it should be appreciated that the customer can make any number of subsequent offers to the vendor terminal 130 until the customer provides an acceptable offer to the vendor terminal 130. However, it should be appreciated that a potential customer having an unlimited number of offering opportunities may choose to make tiny incremental increases in offering price for a commodity until the customer finds an offering price at or incrementally above the floor-price set by the vendor terminal 130.

As such an approach by a customer may unduly limit the profit margin of the vendor, the vendor terminal 130 may, in various embodiments, provide a maximum number of offering opportunities to a customer. For the example above, the vendor terminal 130 may allow a customer up to five refused offers on any particular day or business cycle before the vendor terminal 130 refuses to accept any more subsequent offers for a particular commodity. In other embodiments, the number of refusals may be limited less than five offers, e.g., three refused offers, two refused offers or even a single refused offer before the vendor terminal 130 refuses to accept any further offers for the commodity at issue.

Depending on the particular nature of the commodity, the relevant market dynamics or any other number of factors, the length of time that a particular customer may be precluded from submitting further offers may vary dramatically. For example, in various markets where a floor-price changes slowly, the customer may be precluded from submitting subsequent offers for a business day or more. In other markets where a floor-price may change faster, the time for preclusion may be limited to but a few hours. Accordingly, the particular time that a customer may be precluded from submitting offers on a commodity can vary according to any number of factors without departing from the spirit of the scope of the present invention.

The exemplary network 120 can be a portion of the Internet. However, in various embodiments, the network 120 can be any known or later developed combination of systems and devices capable of conducting information between the two terminals 110 and 130, such as a public switch telephone network (PSTN), a local area network, a wide area network, an intranet, the Internet, portions of a wireless network, and the like. Similarly, the exemplary links 112 and 122 can be electronic systems running transmission control protocol/Internet protocol (TCP/IP) on the Internet. However, in various embodiments, the exemplary links 112 and 122 can be any known or later developed combinations of systems and devices capable of facilitating communication between the network 120 and the terminals 110 and 130, such as RS-232 links, 10baseT links, 100baseTX links, Ethernet links, optical-based links, wireless links, sonic links and the like.

The terminals 110 and 130 can be personal computers having a variety of peripherals capable of communicating with the network 120 and further transforming various signals, such as visual, audio and text information into electronic form while similarly transforming various received electronical signals into appropriate physical signals. However, in various embodiments, either of the exemplary terminals 110 and 130 can be any combination of personal computers, servers, personal digital assistants (PDAs), conventional or cellular phones with graphic displays or any other known or later developed devices that can communicate with the network 120 over respective links 112 and 122 and transform various signals into electronical form, while similarly transforming various received electronic signals into physical form.

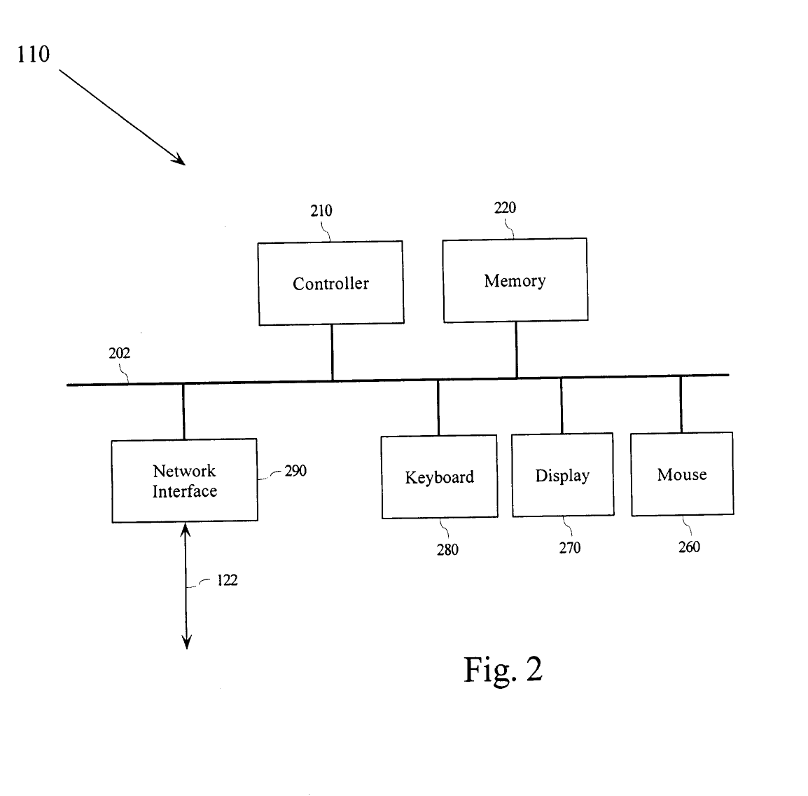

FIG. 2 is a block diagram of the customer terminal 110 of FIG. 1. As shown in FIG. 1, the customer terminal 110 includes a controller 210, a memory 220, a mouse 260, a display 270, a keyboard 280, and a network interface 290. The above components 210-290 are coupled together using a control/data bus 202. Although the exemplary customer terminal 110 uses a bussed architecture, it should be appreciated that the functions of the various components 210-290 can be realized using any number of architectures, such as architectures based on dedicated electronic circuits and the like.

In operation, a customer using the keyboard 280 and mouse 260 can provide a number of instructions to the controller 210 such that the customer terminal 110 can establish communication with a vendor terminal (not shown) via network interface 290 and link 122. As the customer provides various instructions and information to the vendor terminal, the customer can receive various visual, audio and graphic information from the vendor terminal, which can be stored in memory 220 and subsequently displayed on the display 270.

As discussed above, after a customer has made initial contact with a vendor terminal, the customer can provide a customer identification number along with a password that can enable the vendor terminal to identify and verify the customer's identity. After the customer has provided the customer identification number and password, the customer can then attempt to purchase any number of commodities, such as plastics, various fuels, various metals, food products and the like, by submitting an offer, which can include an offering price for a particular quantity of a desired commodity.

Assuming that the vendor terminal has accepted the customer's offer, the vendor terminal can transmit, and the customer terminal 110 can receive, information relating to the acceptance, such as an Internet web-page containing detailed information about the acceptance along with various related terms and conditions, which the customer terminal 110 can present on the display 270.

However, assuming that the vendor terminal refuses the initial offer, the vendor terminal can transmit information to the customer terminal 110 relating to the refusal, which can similarly be displayed on the display 270.

As discussed above, once an offer is refused, the customer may submit any number of subsequent offers until the customer provides an offer acceptable to the vendor terminal. However, it should again be appreciated that the vendor terminal may provide but a limited number of offer/acceptance opportunities for a given commodity and the vendor terminal may refuse subsequent offers after a predetermined number of refused offers has been made.

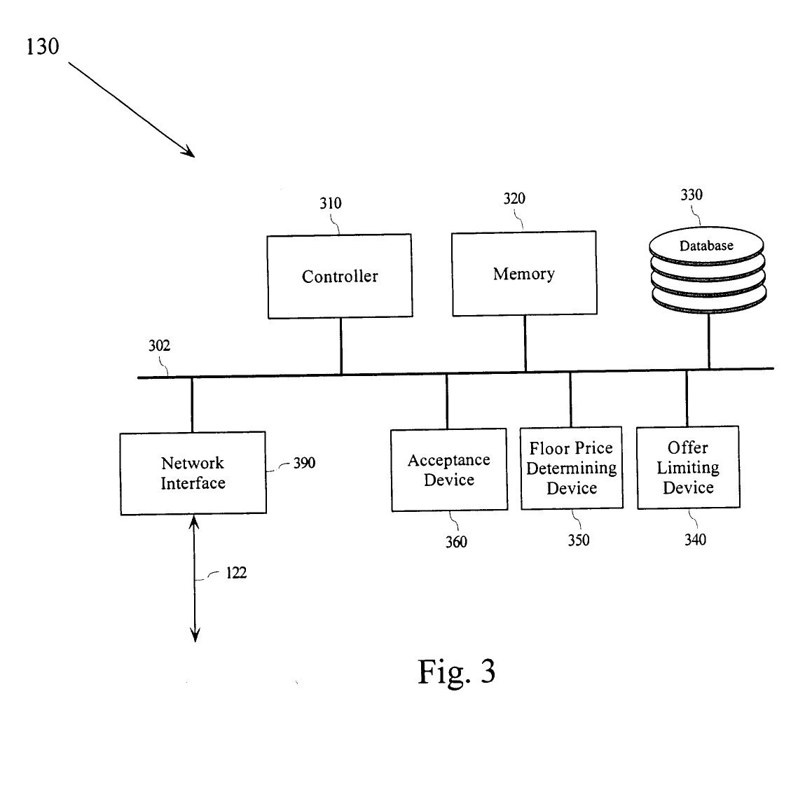

FIG. 3 is a block diagram of a vendor terminal 130 according to the present invention. As shown in FIG. 3, the vendor terminal 130 includes a controller 310, a memory 320, a database 330, an offer limiting device 340, a floor-price determining device 350 and a network interface 390. The above components to 310-390 are coupled together using a control/data bus 302. Although the exemplary vendor terminal 130 uses a bussed architecture, it should be appreciated that the functions of the various components 310-390 can be realized using any number of architectures, such as architectures based on dedicated electronic circuits and the like.

In operation and under control of the controller 310, the network interface 390 can receive various information and commands from a customer terminal (not shown) over a network using network interface 390 and link 122. Once received, the controller 310 can store the received information and commands in memory 320.

As discussed above, the vendor terminal 130 can receive various initial information from a customer, such as a customer identification number and password. Upon reception of a valid customer identification number and password, the controller 310 can access any relevant information concerning the customer that may reside in the database 330.

Next, the vendor terminal 130 can receive various commands and information relating to a desired commodity that a customer may wish to purchase including a particular variant of the commodity, the quantity of the commodity desired and the like along with an offering price for the desired commodity.

It should be appreciated that the exemplary vendor terminal 130 can be configured for one-one-one bartering, as opposed to being configured to accept competing bids simultaneously from various potential buyers in a bidding-type environment. Accordingly, it should be appreciated that an “offer” may be differentiated from a “bid”. However, in other embodiments, it should be appreciated that the vendor terminal 130 can be configured to accept various offers from a variety of potential buyers simultaneously in a competitive bidding environment.

Once the commodity information and offering price are received, the controller 310 can provide information about both the customer and the commodity residing in a database 330 to the floor-price determining device 350.

The floor-price determining device 350 can receive the commodity information from the database 330, as well as information relating to the customer, and determine a floor-price. As discussed above, a floor-price can be the minimum price that a vendor is willing to except for a given offer. The exemplary floor-price determining device 350 uses a parametric equation to determine an acceptable floor-price. However, it should be appreciated that in various embodiments, the floor-price determining device 350 can use any useful approach that can determine a rational a floor-price without departing from the spirited scope of the present invention. Once the floor-price determining device 350 has calculated the floor-price for the commodity of interest, the floor-price determining device 350 can provide the floor-price to the acceptance device 360.

The acceptance device 360 can receive the floor-price along with the offering price provided by the customer and determine whether the offer is acceptable, i.e., whether the offering price exceeds the floor-price. If the offer is acceptable, the acceptance device 360 provides an appropriate signal to the controller 310. The controller 310 then can provide an indication to the customer that the offer has been accepted, such as a web-page containing detailed information about the offer, the offering price, shipping terms and so on.

However, assuming that the acceptance device 360 refuses the offer, i.e., the floor-price exceeds the offering price, the acceptance device 360 can provide an appropriate signal to the controller 310. The controller 310, in turn, can provide an indication to the customer that the offer has been refused, and in various embodiments, the controller 310 can provide an indication to the customer that the vendor terminal 130 is willing to accept subsequent offers on the commodity.

Assuming that the customer wishes to submit another offer on the commodity, the controller 310 can receive and forwarded the offer to the acceptance device 360. The acceptance device 360 can then make a subsequent acceptance or refusal provide the appropriate indication to the controller 310. This cycle of receiving offers and providing an acceptance or refusal indication can continue until the vendor terminal 130 accepts an offer, the customer fails to provide further offers or a maximum number of refusals has been generated by the acceptance device 360.

That is, in various embodiments, as the acceptance device 360 generates acceptance or refusals, the acceptance device 360 can provide the appropriate signals to the offer limiting device 340. The offer limiting device 340 can receive the signal and compare the number of -refusals to a maximum number of allowed refusals. As mentioned above, in order to prevent a customer from incrementally increasing an offering price to glean the vendors floor-price, the offer limiting device 340 can limit the maximum number of refusals. Upon reaching a maximum number of refusals, the offer limiting device 340 can provide an indication to the controller 310 that a maximum number of refusals has been reached. The controller 310 in turn can provide an indication to the customer that the customer has submitted an unacceptable number of offers and that no more offers will be considered for a limited time period. The vendor terminal 130 can then refuse to accept any further offers regarding the commodity at issue until the specified time period has elapsed or otherwise suspended.

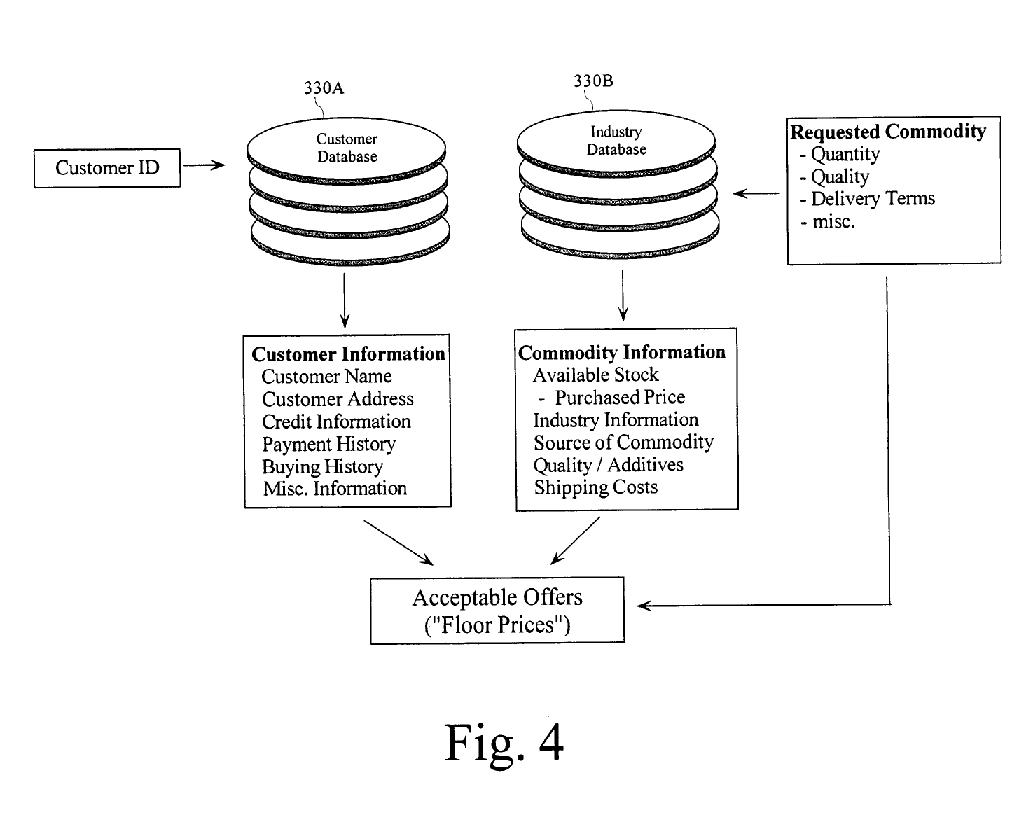

FIG. 4 is a representation of the various information that can be used to generate a floor-price. As shown in FIG. 4, the database 330 of FIG. 3 can be conceptually divided into a customer database 330A and an industry database 330B.

In operation, a customer ID may be applied to the customer database 330A such that an array of information about the customer may be accessed, such as the customer's name, customer's address, the customer's credit information and/or payment history, the customer's buying history as well as other various miscellaneous information. Similarly, information relating to the commodity of interest may be accessed from the industry database 330B, such as the available stock of the commodity, the purchased price of the commodity, market information/industry information, the quality or source of the commodity, any additives or optional modifications to the commodity, various shipping costs and the like.

As shown in FIG. 4, the customer information, industry information and the information related to a commodity can be provided to determine what an acceptable offering price, i.e., floor-price, should be for the requested commodity.

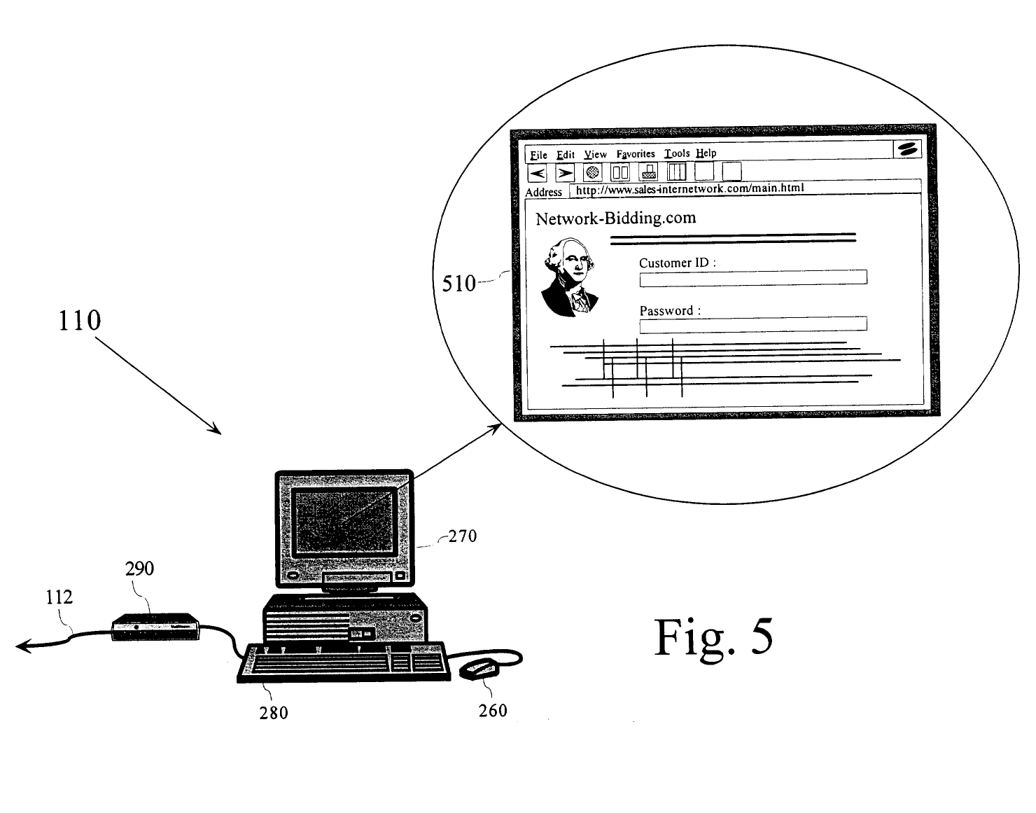

FIG. 5 depicts the customer terminal 110 of FIGS. 1 and 2 with the display 270 presenting a home page 510 of a vending apparatus, such as the vendor terminal 130 of FIGS. 1 and 3. As shown in FIG. 5, the home page 510 can include various information about the vendor and further provide a number of fields such that a customer can provide a customer identification number and password. As discussed above, a customer identification and password can both verify a customer's identity and allow a vendor terminal to access any stored information it might contain concerning the customer.

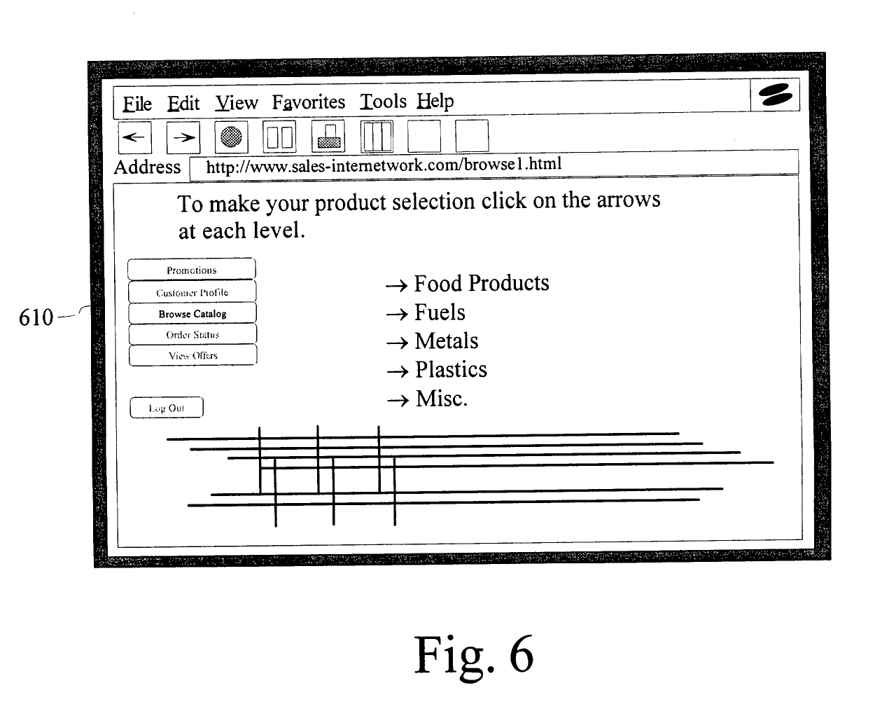

FIG. 6 depicts a first web-page 610 relating to a hierarchy of web-pages that can allow a customer to purchase any number of commodities, such as food products, fuels, metals, plastics and the like.

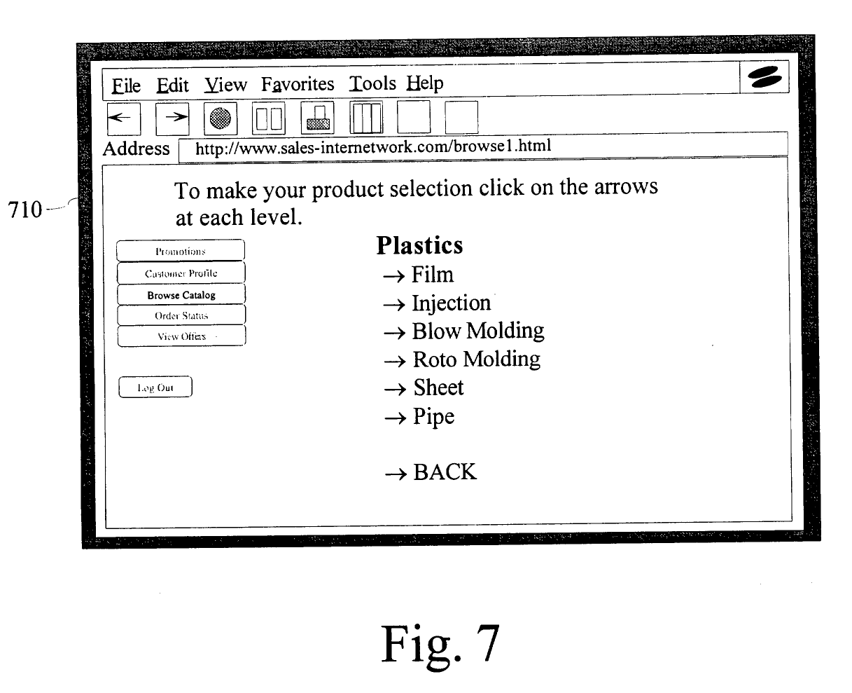

FIG. 7 depicts a second web-page related to the hierarchy of web-pages that can allow a customer to purchase any one of a number of plastic products. As shown in FIG. 7, the second web-page 710 provides a number of options related to plastics including films, injection, blow-molding, roto-molding, sheet and pipe options. However, the available options of the second web-page 710 can vary according to any form of useful hierarchy that can allow a customer to select a particular plastic commodity.

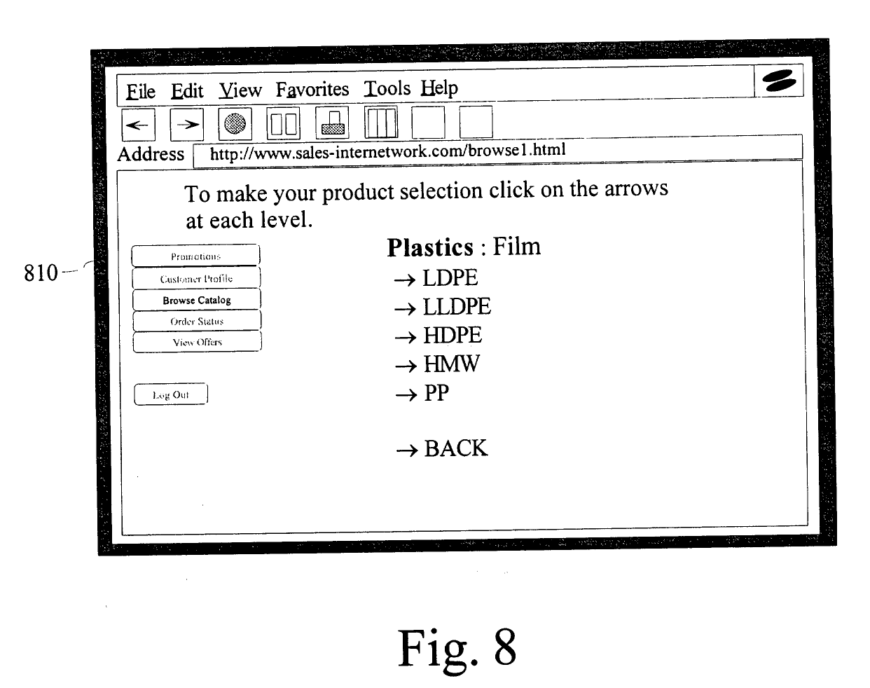

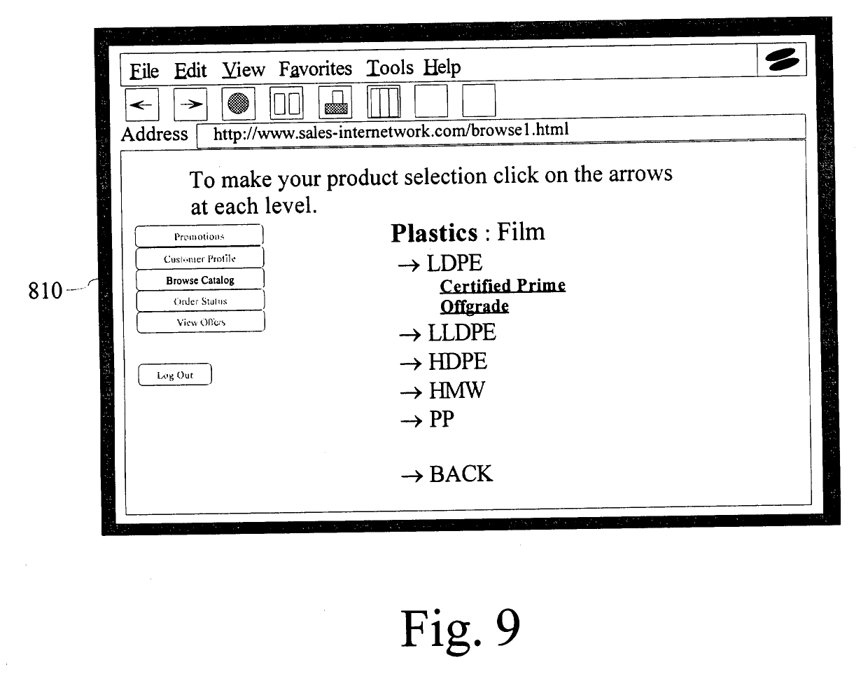

FIG. 8 depicts a third web-page 810 relating to a number of film plastics that a customer can select including LDPE, LLDPE, HDPE, HMW and PP plastics. FIG. 9 depicts the third web-page 810 of FIG. 8 as the third web-page 810 provides a number of sub-menu options for LDPE plastics.

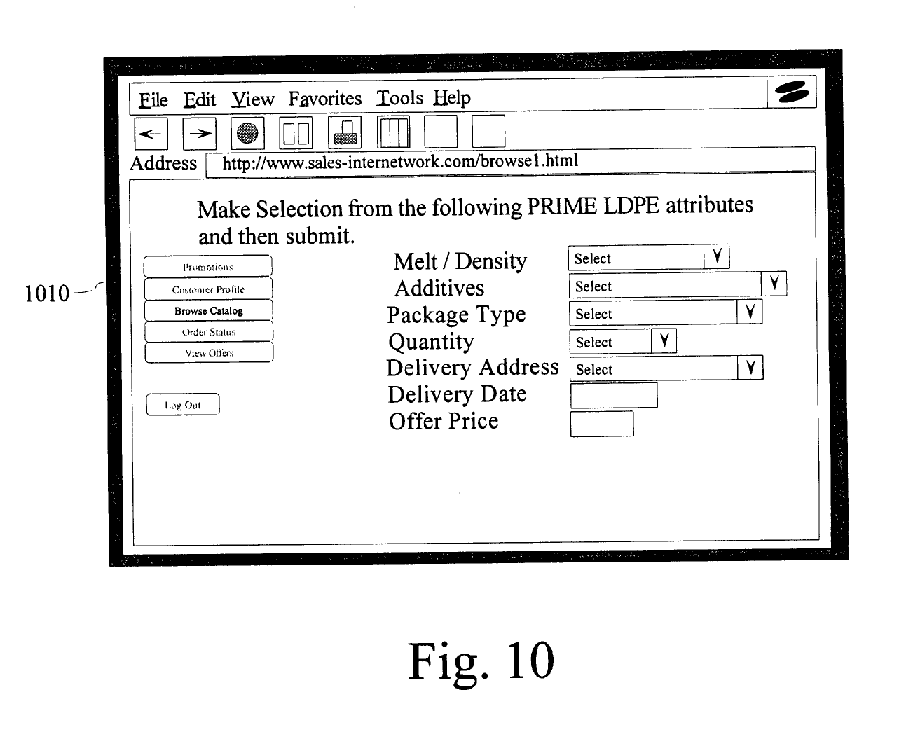

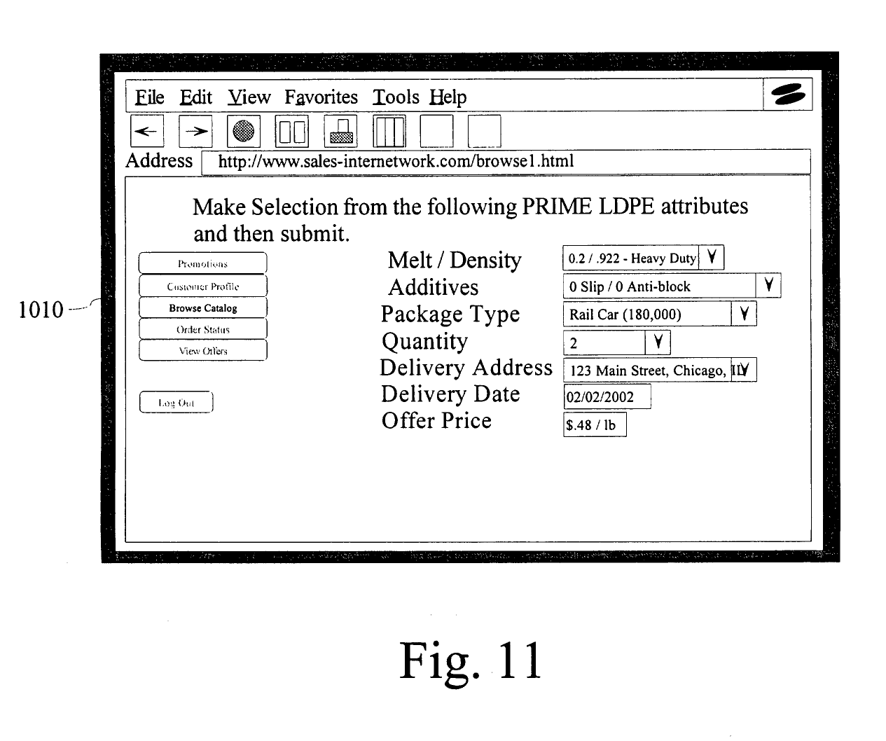

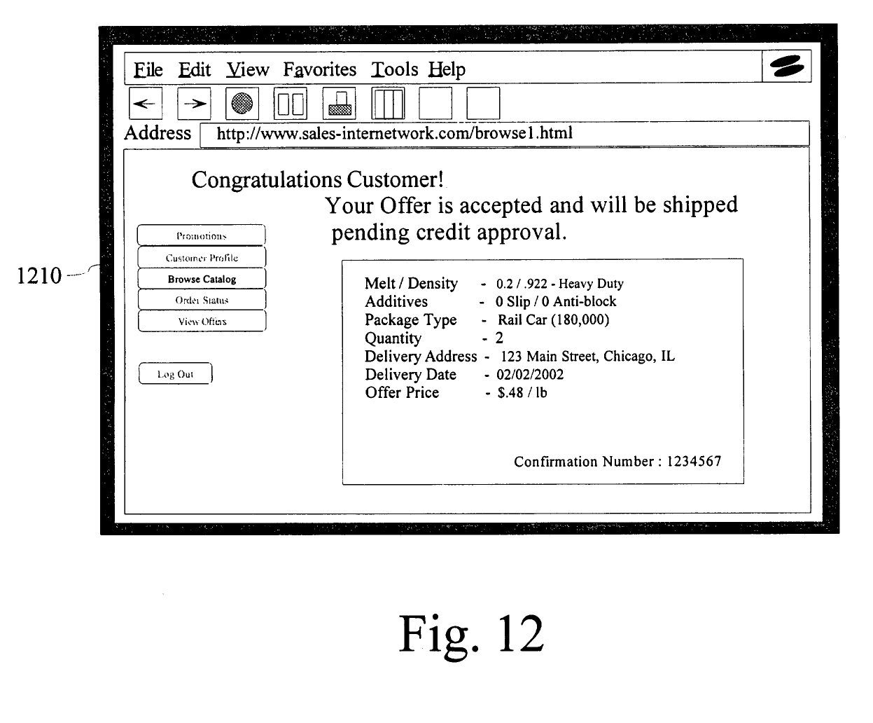

FIG. 10 provides a first data entry web-page 1010 that can allow a customer to enter/select various details/attributes about a particular commodity, which for the present example includes a certified prime LDPE plastic. As shown in FIG. 10, various attributes can include the melting point/density of the plastic, various additives, packaging type, quantity, delivery address, delivery date and the offering price. FIG. 11 depicts the entry web-page 1010 of FIG. 10 after a customer has provided detailed information about the desired plastic commodity as well as delivering terms and an offering price. As discussed above, various offers by a customer may be either accepted or refused. Assuming that a particular offer is accepted, FIG. 12 provides an acceptance web-page 1210 informing the customer that his offer has been accepted as well as information relating to the sale and a confirmation number.

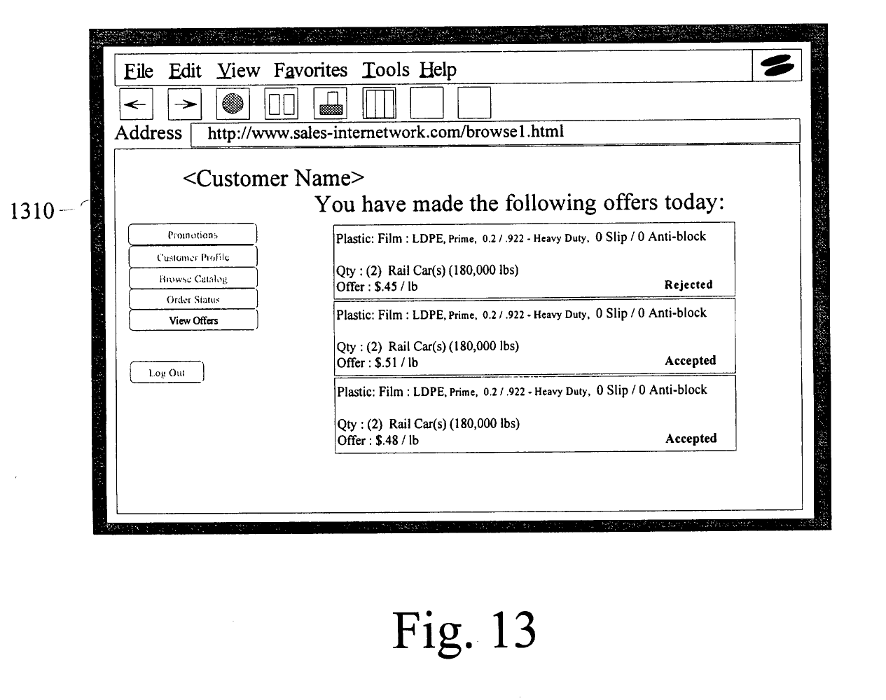

However, assuming that a particular offer is refused, a customer should be appropriately informed. According, FIG. 13 can provide a customer with a history web-page 1310 that can inform or remind the customer of the various offers that the customer has presented to a vendor terminal for a particular commodity.

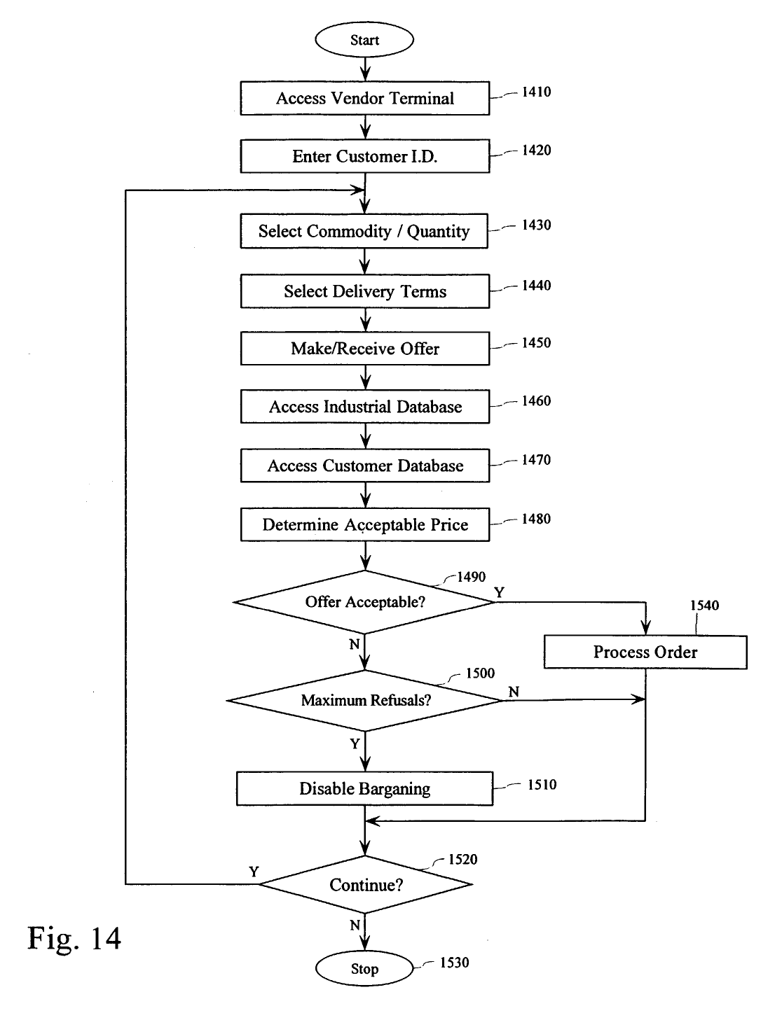

FIG. 14 is a flowchart outlining an exemplary operation for doing business over a network, such as the Internet. The process starts in step 1410 where a customer accesses a vending device having a web-site on the Internet. While the exemplary process is envisioned to occur over the Internet, as discussed above it should be appreciated that the exemplary process can take place over any form of network. Next, in step 1420, the customer can enter a customer ID to the vendor terminal as well as a password or any other information helpful to identify/verify the customer's identity and provide a secure transaction. The process continues to step 1430.

In step 1430, the customer can select a commodity of interest, as well as the desired quantity of the selected commodity. As discussed above, the exemplary process can be used to purchase one of a variety of plastics or other polymers. However, in other exemplary embodiments, the process can be used to purchase food-based products, fuels, metals or any other commodity capable of being marketed and/or sold over a network. Next, in step 1440, the customer can select the desired delivery terms by which the customer wishes to receive the selected commodity. Then, in step 1450, the customer can submit an offering price to the vendor terminal and the vendor terminal can receive the offering price. Control continues to step 1460.

In step 1460, the vendor terminal can access an industrial database that contains various information about the selected commodity of step 1430. As discussed above, the industrial database can contain any information useful to determine a floor-price including the availability of the selected commodity in general, the available stock of the particular vendor, a minimum acceptable profit, the cost of delivery or any other known or later recognized data useful for determining a floor-price. Next, in step 1470, the vendor terminal can access a customer database, which can contain information particular to the customer. As discussed above, various useful customer information can include the customer's credit information and/or payment history, the buying history of the customer, the particular industry in which the customer resides or any other known or later recognized aspect of customer information useful for determining a floor-price. Control continues to step 1480.

In step 1480, a floor-price is determined based on information from the industrial database, the customer database and information about the commodity selected, such as the desired quantity of the commodity. Next, in step 1490, a determination as to whether the offer is acceptable, i.e., whether the offered price of step 1450 exceeds the floor-price of step 1480. If the offering price is acceptable, control jumps to step 1540; otherwise, control continues to step 1500.

In step 1540, because the offer was accepted, the customer's order can be processed. In the exemplary embodiment, it is envisioned that processing an accepted order can include providing the customer with some form of indication that his offer has been accepted along with various details about the terms and conditions of the purchase as well as fulfilling the order.

Otherwise, in step 1500, because the offer was not acceptable, a determination is made as to whether a maximum number of refusals has been made regarding the selected commodity. As discussed above, by providing a limit as to the maximum number of refusals that a vendor terminal may accept, the vendor can be more likely to receive an offer that is both acceptable to the customer while provide a profit margin incrementally greater than the floor-price. If the maximum number of refusals has been made, control continues to step 1510; otherwise, control jumps to step 1520.

In step 1510, because a maximum number of refusals has been made, the vendor terminal can disable a customer's capacity to make further offers on the commodity at issue over a predetermined time period. Next, in step 1520, a determination is made as to whether to continue the bargaining process, either with a new commodity or with the first commodity selected in step 1430. If the bargaining process is to continue, control jumps back to step 1430; otherwise, control continues to step 1530 where the process stops.

The foregoing description of various embodiments have been presented for purposes of illustration and description. It is not intended to be exhaustive or to limit the invention to the precise form disclosed, and modifications and variations are possible in light of the above teachings or may be acquired from practice of the invention. The embodiments were chosen or described in order to explain the principles of the invention and enable one of ordinary skill in the art to utilize this systems with various modifications as would be suited to a particular use as contemplated. It is intended that the scope of the various embodiments be defined by the claims appended hereto, and their equivalence.

What is claimed is:

1. A method for doing business over a network, comprising:
receiving a first offer relating to a first commodity from a customer over the network;
deciding whether to accept or decline the first offer based on at least a floor-price of the first commodity; and
informing the customer whether the first offer is accepted or declined.

2. The method of claim 1, wherein the step of deciding is independent of any competing offer by a competing buyer.

3. The method of claim 1, wherein the network is the Internet.

4. The method of claim 1, wherein the floor-price is not revealed to the customer before the first offer.

5. The method of claim 1, wherein the commodity is a polymer.

6. The method of claim 1, wherein the commodity is a fuel product or a metal.

7. The method of claim 1, wherein the commodity is a food substance.

8. The method of claim 3, wherein the floor-price is not revealed to the customer before the first offer.

9. The method of claim 8, wherein the step of deciding is independent of any competing offer by a competing buyer.

10. The method of claim 8, wherein the step of deciding is performed by a device acting on behalf of a distributor of the first commodity.

11. The method of claim 10, wherein the commodity is a polymer.

12. The method of claim 8, wherein the step of deciding is performed by a device acting on behalf of a producer of the first commodity.

13. The method of claim 10, wherein the step of deciding is further based on at least one of a requested quantity of the first commodity, a requested quality of the first commodity and an availability of the first commodity.

14. The method of claim 10, wherein the step of deciding is further based on the source of the first commodity.

15. The method of claim 10, wherein the step of deciding is further based on a delivery parameter.

16. The method of claim 13, wherein the step of deciding is further based on one or more customer parameters.

17. The method of claim 16, wherein the one or more customer parameters include the customer's credit rating.

18. The method of claim 16, wherein the one or more customer parameters include an index based on the customer's buying history.

19. The method of claim 16, wherein the one or more customer parameters include an index based the customer's credit rating and the customer's payment history.

20. The method of claim 3, wherein the first offer is declined and the method further comprises receiving one or more subsequent offers relating to the first commodity.

21. The method of claim 20, wherein the first offer is declined and the method further comprises receiving one or more subsequent offers relating to the first commodity.

22. The method of claim 21, further comprising refusing to consider an offer based on a number of past declined offers provided by the customer over a predetermined time period.

23. The method of claim 21, wherein refusing to consider an offer includes the steps of:
determining the number of declined offers; and
comparing the number of declined offers to a refusal limit.

24. The method of claim 23, wherein the refusal limit is less than or equal to five.

25. The method of claim 24, wherein the refusal limit is less than or equal to two.

26. A vending system for doing business over a network, comprising:
an interface that receives a first offer relating to a first commodity from a customer over the network; and
an acceptance device that accepts or declines the first offer based on at least a floor-price of the first commodity.

27. The vending system of claim 26, wherein the network is the Internet.

28. The vending system of claim 27, wherein the interface further informs the customer whether the first offer is accepted or declined.

29. The vending system of claim 28, wherein the vending system does not provide the floor-price to the customer before receiving the first offer.

30. The vending system of claim 28, wherein the commodity is a polymer.

31. The vending system of claim 28, wherein the commodity is one of a fuel product, a metal and a food substance.

32. The vending system of claim 28, wherein the vending system is operated for a distributor of the first commodity.

33. The vending system of claim 32, wherein the commodity is a polymer.

34. The vending system of claim 28, wherein the vending system is operated for a producer of the first commodity.

35. The vending system of claim 32, wherein the acceptance device basis its decision on at least one of a requested quantity of the first commodity, a requested quality of the first commodity and an available quantity of the first commodity.

36. The vending system of claim 32, wherein the acceptance device basis its decision on at least a delivery parameter.

37. The vending system of claim 32, wherein the acceptance device basis its decision on at least one or more customer parameters.

38. The vending system of claim 37, wherein the one or more customer parameters include the customer's credit rating.

39. The vending system of claim 37, wherein the one or more customer parameters include the customer's buying history.

40. The vending system of claim 37, wherein the one or more customer parameters include the customer's credit rating and the customer's payment history.

41. The vending system of claim 27, further comprising a limiting device that receives information from the acceptance device and is configured to cause the vending system to refuse to consider an offer based on a number of past declined offers provided by the customer.

42. The vending system of claim 41, wherein the limiting device is configured to decline an offer based on five or less past declined offers.

43. The vending system of claim 41, wherein the limiting device is configured to decline an offer based on two or less past declined offers.

44. A method for doing business over a network, comprising:
transferring at least one of an acceptance or a refusal signal relating to a first commodity from a vendor terminal to a customer terminal over the network, wherein the transmitted acceptance or refusal is based on at least a floor-price of the first commodity.

45. The method of claim 44, wherein the transmitted acceptance or refusal is further based on a first offer relating to the first commodity from the customer.

46. The method of claim 45, wherein the network is the Internet.

47. The method of claim 46, wherein the commodity is a polymer.

48. The method of claim 46, wherein the commodity is one of a fuel product, a metal or a food substance.

49. The method of claim 46, and wherein the vendor terminal has not supplied the floor-price to the customer.

50. The method of claim 49, wherein the commodity is a polymer.

51. The method of claim 49, wherein the vendor is a producer of the first commodity.

52. The method of claim 49, wherein the transmitted acceptance or refusal is further based on at least one of the requested quantity of the first commodity, the requested quality of the first commodity and the availability of the first commodity.

53. The method of claim 49, wherein the transmitted acceptance or refusal is further based on a delivery parameter.

54. The method of claim 49, wherein the transmitted acceptance or refusal is further based one or more customer parameters.

55. The method of claim 54, wherein the one or more customer parameters include the customer's buying history.

56. The method of claim 54, wherein the one or more customer parameters include the customer's credit rating.

57. The method of claim 49, wherein the transmitted signal is a refusal based on a number of past declined offers provided by the customer.

58. The method of claim 57, wherein the transmitted refusal is based on five or less of past declined offers provided by the customer over a predetermined time period.
